(19) United States
(12) Patent Application Publication
(10) Pub. No.: US 2013/0326958 A1
(43) Pub. Date: Dec. 12, 2013

(54) PASSAGE BARRIER

(71) Applicant: Markus Dreher, Steinen (DE)

(72) Inventor: Markus Dreher, Steinen (DE)

(73) Assignee: MAGNETIC AUTOCONTROL GMBH, SCHOPFHEIM (DE)

(21) Appl. No.: 14/000,560

(22) PCT Filed: Feb. 27, 2012
(86) PCT No.: PCT/DE12/00193

§ 371 Date: Aug. 20, 2013

(30) Foreign Application Priority Data
Feb. 28, 2011 (DE) 20 2011 002 309.0

(51) Int. Cl. E05F 15/12

(52) U.S. Cl. CPC E05F 15/12
USPC 49/334

(57) ABSTRACT

The invention relates to a passage barrier for controlling the access a building or a site, comprising a blocking element that can be pivoted or rotated in both directions about an axis in a defined angle from a blocking position in order to grant access, a drive motor and an overload coupling between the output shaft of the drive motor and the drive shaft of the blocking element. According to the invention, the coupling is designed as an asymmetrical overload coupling and the limit torque that must be overcome is greater in one rotational direction than in the other rotational direction of the blocking element. When the limit torque that must be overcome is greater in the direction of the access to a building or a site than in the direction of the exit, a reliable personal access control and, e.g. in a hazardous situation or in case of panic, the largely unhindered leaving of the building or site can be ensured.

The invention relates to a passage barrier for controlling the access to a building or a site, having a blocking element which, in order to grant access, is pivotable or rotatable by a defined angle from a blocking position in both directions about an axis, a drive motor and an overload clutch with adjustable limit torque.

Passage barriers serve to control the access of persons to, for example, buildings or installations, such as railroad stations, airports, corporate sites, etc. in a manner such that subsequent to some type of authorization check or identity check only authorized persons are granted access individually, in that a blocking element of the passage barrier is moved from a position which blocks the passage to a position which opens the passage, and the blocking element is immediately returned to a position which blocks the passage once an authorized person has passed through the passage barrier. However, exiting a building or an installation should be readily possible for all persons without any authorization check or identity check. The possibility of exiting a building or an installation as far as possible without obstruction is required above all for safety reasons, e.g. in a situation of imminent danger or in the event of a panic breaking out. It is known for access to a building or an installation to be controlled by a passage barrier, but for a separate exit therefrom to be provided for exiting the building or the installation. However, there is also the desire that the same passage may be used for entering and exiting a building or an installation, whilst adhering to the applicable security regulations, of course.

Known passage barriers which permit passage in both directions are equipped with an overload friction clutch which has the same limit torque in both directions. For safety reasons, the torque which has to be overcome on the clutch of the passage barrier when exiting a building or an installation should be limited. For example, according to an existing but not generally applicable regulation the force to be applied to the leading edge of a pivotable blocking wing should be at maximum 750 N. In a clutch which has the same limit torque in both directions, however, the limit torque to be overcome for access is also limited to this rather low value by this safety regulation.

It has, however, been found that unauthorized persons have increasingly also been able to gain access to a building or an installation by forcing the blocking element into its open position, which was facilitated by the torque limited in both directions being low and comparatively easy to overcome.

It is an object of the invention to provide a passage barrier at which the access to a building or an installation is controlled effectively and the risk of unauthorized persons gaining uncontrolled access, and even forcibly so by vandalism, is eliminated as far as possible, but exiting the building or the installation, e.g. in a situation of imminent danger or in the event of a panic breaking out, through the same barrier is possible in an uncontrolled and largely unobstructed manner.

According to the invention this is achieved with a passage barrier according to claim 1.

By configuring the clutch between the drive motor and the blocking element as an asymmetrical overload clutch, the torque to be overcome in the access direction can be made higher than the torque to be overcome in the exit direction. In this manner, effective access control, which is secure even in the event of force being used to a building or a site, can be achieved, while at the same time permitting the building or the site to be exited largely without obstruction.

The torque to be overcome should thus be greater in the direction of access to a building or site than in the direction of exit. For example, in a situation of imminent danger or in the event of panic breaking out this overload clutch may then be overcome comparatively easily in the exit direction, this also considerably minimizing the risk of injuries.

Preferably the torque to be overcome in the direction of the access to a building or site should be approximately double that of the direction of the exit. On account of this, a sufficiently high level of resistance against any access gained by force can be achieved, without the required installation space for the overload clutch being increased.

The invention is explained in more detail in the following with reference to the accompanying drawing, in which:

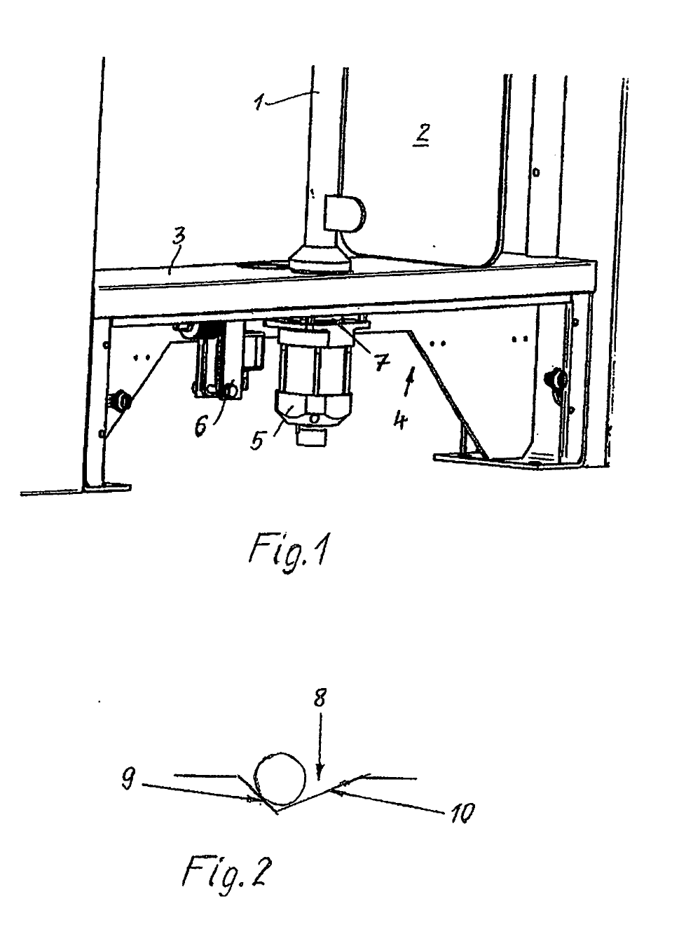

FIG. 1 shows the lower part of a passage barrier and

FIG. 2 shows a detail of an overload clutch of the passage barrier according to the invention.

FIG. 1 shows a passage barrier having a blocking wing as blocking element, said blocking wing 2 being pivotable in both directions by approximately 90° about a column 1 from a position which blocks the passage. A drive shaft (not visible in the drawing), which implements the pivoting movement of the blocking wing 2, extends inside the column 1. Said drive shaft penetrates the plate 3 of a table-like base 4 and is connected beneath the plate 3 to the output shaft of a drive motor 5 via an overload clutch 7. For the safe operation of the passage barrier, a locking unit 6 is additionally provided which securely holds the blocking wing 2 in its closed position and its open position and which permits the drive motor 5, or the blocking wing 2 respectively, to be stopped in short steps or also in any position.

According to the invention, the overload clutch 7 is configured asymmetrically, meaning that the torque to be overcome at said overload clutch 7 in the one pivoting direction of the blocking wing 2, or of any other blocking element, differs from the torque which has to be overcome at said overload clutch 7 in the other pivoting direction, and specifically that the torque which has to be overcome for the access is greater than the torque which has to be overcome at said overload clutch 7 in the exit direction. Preferably the torque for the access is about double the torque for exiting a building or an installation; according to presently known safety regulations, for the access this would thus be approximately 1500 N on the front side of the blocking wing. This is considered on the one hand as being sufficient for effective access control which denies access with a high level of reliability to unauthorized persons even when they are using force; on the other hand, this is implementable also in the usually only small installation space available at a passage barrier, because an overload clutch having this maximum torque does not require more space than one of the overload friction clutches used to date.

Various possibilities are conceivable for implementing such an asymmetrical overload clutch. Overload clutches are known in which balls are located between an outer and an inner clutch body, said balls being able to roll in raceways provided on the clutch bodies. The raceway of the one (outer) clutch body has conical depressions into which the balls are pressed by, for example, a spring arrangement. Once the balls have locked home in the depressions, a form fit is present between the two clutch bodies. Once the torque of the clutch, which has been preset by e.g. a setting nut generating pretension, is exceeded in a clutch outer body blocked by a blocking unit, the balls are released from the depressions in the ball raceway of the clutch outer body, the form fit is released and the inner clutch body can rotate in relation to the outer, blocked clutch body. In known clutches the depressions are configured symmetrically, e.g. conically, with identically inclined flanks; the limit torque which has to be overcome in order to release the clutch is thus the same in both directions of rotation.

According to one embodiment of the invention, the depressions 8 are configured asymmetrically, e.g.

conically, with asymmetrical flanks 9, 10, i.e. the one flank 9 extends more steeply, the other flank 10 extends in a more gently sloped manner. It is thus ensured that the torque to be overcome in the direction of the steep flank 9 is greater than the torque to be overcome in the direction of the gently sloped flank 10. For a passage barrier according to the invention, the pivoting movement of the blocking element 2 therefore has to be implemented in the direction of the steep flank 9 for the controlled access; for as far possible unobstructed exiting the pivoting movement of the blocking element 2 has to occur in the direction of the gently sloped flank 10.

Other embodiments of an asymmetrical overload clutch are conceivable.

### LIST OF REFERENCE SIGNS

1 Column
2 Blocking element, blocking wing
3 Plate
4 Base
5 Drive motor
6 Locking unit
7 Overload clutch
8 Depressions
9 Steep flank
10 Gently sloped flank

1. A passage barrier for controlling the access to a building or a site, having a blocking element which, in order to grant access, is pivotable or rotatable by a defined angle from a blocking position in both directions about an axis, a drive motor and an overload clutch with adjustable limiting torque, characterized in that the clutch is configured as asymmetrical overload clutch (7) and the limiting torque to be overcome in the one direction of rotation is greater than in the other direction of rotation.

2. The passage barrier as claimed in claim 1, characterized in that the limit torque to be overcome in the direction of the access to a building or a site is greater than in the direction of the exit.

3. The passage barrier as claimed in claim 2, characterized in that the limit torque to be overcome in the direction of the access to a building or a site is approximately double that in the direction of the exit.
